(19) United States
(12) Patent Application Publication
(10) Pub. No.: US 2007/0296128 A1
(43) Pub. Date: Dec. 27, 2007

(54) Vibration damping elastic device

(75) Inventors: Seiya Asano, Niwa-gun (JP); Masami Endo, Niwa-gun (JP)

Correspondence Address: OLIFF & BERRIDGE, PLC, P.O. BOX 320850, ALEXANDRIA, VA, 22320-4850, US

(73) Assignee: TOKAI RUBBER INDUSTRIES, LTD., KOMAKI-SHI (JP)

(21) Appl. No.: 11/819,434

(22) Filed: Jun. 27, 2007

(30) Foreign Application Priority Data
Dec. 16, 2005 (JP) 2005-363370

(51) Int. Cl. F16F 13/00

(52) U.S. Cl. 267/140.12

(57) ABSTRACT

A rubber vibration damping device including: a main rubber elastic body that connects together a first mounting member and a second mounting member; and a stopper mechanism that limits in cushionwise fashion relative displacement of the first mounting member and the second mounting member by means of contact of a pair of contact faces thereof. A stopper rubber is formed on each of the pair of contact faces in the stopper mechanism and a multitude of parallel grooves and lands are formed on the respective contact faces, with the grooves and lands on one of the contact faces and the grooves and lands on an other of the contact faces oriented in directions intersecting one another.

### TECHNICAL FIELD

The present invention relates to a rubber vibration-damping device furnished with a stopper mechanism that provides cushionwise limitation of the amount of relative displacement, by means of mutual contact of stopper rubbers.

### BACKGROUND ART

One type of known vibration-damping device adapted for installation between vibration transmitting members is one provided with elastic striking sections disposed between a pair of mounting members that are attached to the vibration transmitting members. One such device is disclosed in Patent Citation 1 (JP-U 5-30584), for example. With this device, it is possible to limit in cushionwise manner the amount of relative displacement of the pair of mounting members through contact via the elastic striking sections of the two contact faces of the pair of mounting members, as well as to establish a high spring ratio between the direction of contact and the direction orthogonal thereto.

It has also been proposed to provide small projections on the surface of an elastic striking section, for the purpose of reducing noise and shock as they striking against each other. Typically, the small projections will be composed of a multitude of granulated projections, independent projections, or the like.

However, in some instances it is difficult to achieve sufficient reductions in noise and shock simply by providing such granulated projections or independent projections (hereinafter collectively termed “small projections”). Moreover, while it is considered necessary to have the small projections project to a considerable height in order to achieve sufficient reductions in noise and shock, doing so results in considerable strain occurring in the small projections, which creates the problem of inability to assure durability.

For this reason, it has been contemplated to provide small projections on both of the contact faces, such as taught in Patent Citation 1 for example. By doing so it is contemplated to reduce the projecting height of the small projections on either one of the contact faces and to assure durability, while at the same time improving overall effectiveness in reducing noise and shock.

However, experimentation and research conducted by the inventors has shown that even where small projections have been formed on both contact faces, there are still instances in which sufficient noise reduction will difficult to achieve. In particular, while a certain level of improvement in noise reduction can be expected when the pair of contact faces strike one another in the direction of opposition, in the event that the faces experience relative displacement in the direction orthogonal to the direction of opposition (i.e. the direction of extension of the contact faces) in addition to striking one another, a relatively high level of noise tends to occur.

Specifically, there is a considerable noise problem where, for example, the vibration-damping device is employed as a suspension bushing in a rear trailing arm suspension, for the purpose of vibration-damping linkage of the vehicle front edges of the swing arms to the vehicle body to either side of the vehicle across its width, with the center axis of the vibration-damping device inclined in the front-back direction from the vehicle width direction.

More specifically, during up-and-down swinging of the swing arm, the load input, which would be directed in the axis-perpendicular direction if the center axis of the suspension bushing were extending in the vehicle width direction, is instead input in a shearing direction which represents a combination of the axis-perpendicular direction with a twisting direction, due to the center axis of the bushing being positioned inclined by a prescribed angle in the front-back direction from the vehicle width direction. As a result, the problem of noise tends to occur due to so-called scraping displacement whereby the two contact faces of the mounting member on the inner side and the mounting member on the outer side of the bushing undergo relative displacement in the shearing direction while in contact with one another via the elastic strike faces.

The reason why noise reduction during scraping displacement cannot be achieved even where a multitude of small projections are provided on both contact faces is not fully understood. However, research conducted by the inventors suggests that one cause may be that the multitude of small independent projections formed on the two contact faces overlap not just at their tips but at their side faces as well, rubbing together or getting hung up one another.

Moreover, it is hypothesized that even where the small projections disposed on the two contact faces have been positioned in opposition, when the two contact faces strike against each other in the direction of opposition, the small projections will not necessary strike one another at their tips. The small projections on one of the contact faces may strike against areas of the other contact face in which the small projections are absent. Consequently, at present it is also difficult to achieve the desired shock reducing effect when the elastic striking sections strike together.

[Patent Citation 1] JP-5-30584-U

### DISCLOSURE OF THE INVENTION

### Problem the Invention Attempts to Solve

With the foregoing in view, it is an object of the present invention to address the above problems by providing a rubber vibration-damping device of novel construction furnished with an exceptionally durable elastic striking portion which effectively suppresses noise even in instances where relatively displacement in a direction along the plane occurs between the contact faces, and which is furthermore adapted to improve noise and shock reducing effect in the direction of opposition of the contact faces.

### Means for Solving the Problem

The modes of the present invention for the purpose of addressing the aforementioned problems will be described hereinbelow. Constituent elements employed in the modes set forth herein may be employed in any possible combination. The modes and technical features of the present invention are not limited to those set forth herein and should be understood as being set forth in the entire specification and the accompanying drawings, or being appreciable on the basis of an inventive concept apparent to the ordinary practitioner from the disclosure herein.

Specifically, the present invention features a rubber vibration-damping device including: a main rubber elastic body that connects together a first mounting member and a second mounting member; and a stopper mechanism that limits in cushionwise fashion relative displacement of the first mounting member and the second mounting member by means of contact of a pair of contact faces thereof, the rubber vibration damping device being characterized in that a stopper rubber is formed on each of the pair of contact faces in the stopper mechanism and a multitude of parallel grooves and lands are formed on the respective contact faces, with the grooves and lands on one of the contact faces and the grooves and lands on an other of the contact faces oriented in directions intersecting one another.

In the rubber vibration-damping device constructed in accordance with the present invention, the faces that initially strike one another in the pair of stopper rubbers (initial contact faces) are constituted exclusively by the distal edges of grooves and lands oriented in directions that intersect one another. Thus, it is possible to achieve small planar area on the part of the abutting areas of the contact faces created by striking of the intersecting grooves and lands, and to thereby effectively reduce the noise occurring during scraping displacement, i.e. relative displacement that takes place in the direction of extension of the contact faces with both sets of grooves and lands abutting one another. It is moreover possible to achieve excellent reduction of noise that may occur when water or the like is adhering to the contact faces and scraping displacement takes place with the contact faces in a wetted state.

In particular, by orienting the grooves and lands of the two contact faces in directions intersecting one another, it is possible to avoid lands of one face becoming caught in the grooves of the other. Consequently, it is possible to avoid mechanical catching in the event that the two contact faces experience scraping displacement, such as can occur with small projections such as granulated projections or independent projections of conventional design. It is possible thereby to not only improve endurance of the contact faces furnished with the grooves and lands, but also to consistently achieve the desired noise reduction.

Moreover, the desired cushioning action is sufficiently achieved on the basis of stable superposition of the two contact faced via their intersecting grooves and lands, thereby advantageously affording noise reduction when the two contact faces strike one another, for example.

The rubber vibration-damping device of the present invention will preferably employ a structure wherein a projecting height of the grooves and lands on one of the contact faces differs from a projecting height of the grooves and lands on the other of the contact faces. This structure makes it possible to more easily tune the spring characteristics and cushioning action when the pair of contact faces strike each other, and achieve further improvement in vibration absorbing capability and noise reducing action. Moreover, even if lands on one contact face become caught in grooves on the other contact face, it will nevertheless be possible to avoid the grooves and lands coming into intimate contact, thus preventing the occurrence of noise arising from the state of contact, such as sticking.

Furthermore, the rubber vibration-damping device of the present invention will preferably employ a structure wherein one of the contact faces is larger than the other of the contact faces, and a curving portion with a curvature radius greater than a height dimension of the grooves and lands is formed on an edge of a smaller one of the contact faces. By means of such a structure, the state of contact will be stable during displacement from the smaller contact face towards the larger contact face, and as such the structure may be advantageously employed particularly in rubber vibration-damping devices in which displacement from one contact face towards the other contact face is difficult to stabilize in association with load input in a twisting direction, for example. Moreover, the small striking area affords further reduction in noise, such striking noise or scraping noise. In particular, by means of forming a curving portion having a large curvature radius at the edge of the smaller contact face, it is possible to prevent the edge from becoming caught in the grooves, thus affording further improvement in endurance and noise reducing effect.

In preferred practice, in the rubber vibration-damping device according to the present invention, wherein the grooves and lands on one of the contact faces and the grooves and lands on the other of the contact faces have an intersection angle of between 45 and 135 degrees. Noise associated with scraping displacement of the two contact faces will be more effectively suppressed thereby. Moreover, if the intersection angle of the grooves and lands of the two contact faces diverges from the range of between 45 and 135 degrees, the planar area of the abutting portions will be larger than necessary, which is undesirable in terms of suppressing noise occurring primarily due to scraping displacement and so on.

Furthermore, the rubber vibration-damping device of the present invention will preferably employ a structure wherein the grooves and lands, viewed in cross section orthogonal to the direction of extension thereof, have a shape in which the cross sectional area of the lands is greater than the cross sectional area of the grooves, with respect to a reference line connecting intermediate positions between the deepest points of the grooves and the apical points of the lands in the grooves and lands. By means of this structure, a sufficient volume of rubber in the lands will be favorably assured, and the desired spring properties and cushioning action based on resilience of the stopper rubber will be more effectively achieved. Moreover, the structure will be more resistant to the lands of one contact face becoming caught in the grooves of the other contact face, thus more effectively suppressing noise caused by catching.

Furthermore, the rubber vibration-damping device of the present invention will preferably employ a structure wherein flat surfaces are formed at distal ends of the lands in the grooves and lands. By means of such a structure, it is possible to further improve the endurance of the lands against jarring striking of the contact faces. Moreover, with the landed and grooved contact faces ill contact with one another, it will also possible to achieve relatively hard spring via the flat surfaces formed at the distal ends of the lands.

In another preferred mode of the rubber vibration-damping device according to the present invention, the grooves and lands will extend in a straight-line pattern on the contact faces. By forming the grooves and lands with a straight-line pattern, it is possible to more consistently assure mutually intersecting areas of contact.

In the rubber vibration-damping device according to the present invention, the grooves and lands need not be continuous over their entire length, nor do they need to have unchanging cross section over their entire length. For example, a mode wherein the grooves and lands are divided midway along their lengthwise direction, with lands or grooves that connect adjacent lands or grooves being formed at these locations midway along their lengthwise direction would be possible as well. Since it is undesirable for the grooves to form independent recesses (i.e. recesses that be covered and sealed off during contact) on the contact faces, it would be possible to employ a mode wherein, for example, in order to prevent the grooves from being sealed off on the contact face, there is formed a communicating slot that traverses in a direction intersecting the direction of extension of the grooves so that the grooves communicate with one another in the width direction through the communicating slot, as so as to communicate with open to an outer region to the outside of the contact face. By means of forming such a communicating slot, the lengthwise center sections of the grooves can be short-circuited to an outer region at a location a shorter distance along the lengthwise direction of the grooves, making it possible to avoid problems such as noise caused by compression or flow of air or other fluid between the contact faces.

In another preferred mode of the rubber vibration-damping device according to the present invention, wherein a fluid chamber whose wall is defined by the main rubber elastic body is formed between opposing faces of the first mounting member and the second mounting member with a non-compressible fluid sealed therein, and the pair of contact faces are positioned in opposition within the fluid chamber. That is, it is possible to implement the present invention in a fluid filled type of rubber vibration-damping device as well, and to thereby achieve a reduction in noise and shock when the contact faces of the stopper mechanism strike one another. Through suitable adjustment of the size and direction of the grooves and lands, it is also possible to rectify the direction of fluid flow between the contact faces due to the fluid being guided through the grooves and lands, in order to achieve effects such as stabilized fluid flow within the fluid chamber.

In particular, the rubber vibration-damping device according to the present invention is applicable to a bowl type rubber mounting or other rubber vibration-damping device of fluid filled type having a first mounting member and a second mounting member positioned in opposition and spaced apart by some distance in a first direction. Likewise the present invention is also applicable to rubber vibration-damping devices of sealed fluid type of cylindrical mounting design or the like. In this case, possible modes may include those such as the following.

Specifically, where the invention is implemented in a cylindrical, fluid filled rubber vibration-damping device for example, a preferred mode would be a cylindrical fluid filled rubber vibration-damping device wherein a shaft member and a intermediate sleeve disposed a prescribed distance away to an outside of the shaft member are connected by a main rubber elastic body; an outer cylindrical member is attached fitting externally about the intermediate sleeve and fluid-tightly covering a plurality of pocket portions formed so as to open onto an outside peripheral face through window portions provided in the intermediate sleeve thereby forming a plurality of fluid chambers respectively having non-compressible fluid sealed therein and giving rise to relative pressure fluctuations during vibration input; and an orifice passage interconnecting the plurality of fluid chambers is formed so as to afford vibration absorbing action on the basis of a fluid flow behavior induced to flow through the orifice chamber during vibration input, the fluid filled rubber vibration-damping device being characterized in that: a stopper mechanism is positioned in opposition within at least one of the fluid chambers and comes into face-to-face contact thereof in order to provide cushionwise limitation of an amount of relative displacement of the shaft member and the outer cylindrical member; and in the stopper mechanism, stopper rubbers are formed on each of a pair of contact faces urged into mutual contact, with a multitude of parallel grooves and lands formed on the respective contact faces, and with the grooves and lands on one of the contact faces and the grooves and lands on an other of the contact faces oriented in directions intersecting one another.

In a preferred mode of the cylindrical, fluid filled rubber vibration-damping device such as the above, wherein the stopper mechanism comprises a first contact portion formed by a rubber elastic body supported by the outer cylindrical member and formed so as to project inwardly in an axis-perpendicular direction within the fluid chamber, and a second contact portion supported by the shaft member and formed so as to project outwardly in the axis-perpendicular direction from a floor of the pocket portion within the fluid chamber so as to be positioned in opposition to the first contact portion in the axis-perpendicular direction, and the pair of contact faces comprise a projecting distal end face of the first contact face and a projecting distal end face of the second contact face. By supporting the first contact portion and the second contact portion by means of the outer cylindrical member and the shaft member in this manner, it is a simple matter to realize a stopper mechanism of structure in accordance with the invention, able to afford effective stopper function in the axis-perpendicular direction. In a more preferable arrangement, there will be provided a plate shaped core that straddles the window portions formed in the intermediate sleeve, with the outside edge portion of the core held clamped between the intermediate sleeve and the outer cylindrical member, and the first contact portion will be constituted by a rubber elastic body vulcanization bonded in a state projecting out from the inside face of the core. In a still more preferable arrangement, part of the orifice passage will be formed on the outside periphery of the core, between the core and the outer cylindrical member which covers the window portions of the intermediate sleeve.

In another preferred mode of the rubber vibration-damping device which pertains to the present invention, wherein the multitude of grooves and lands on at least one of the first contact portion and the second contact portion are of multiple types that differ in cross sectional shape.

Here, different cross sectional shape of the multiple types of grooves and lands includes those of similar shape but different size, for example. In particular, as multiple types of grooves and lands that differ in cross sectional shape, there could favorably employed those of different height or depth for example.

By employing such multiple types of grooves and lands, it is possible to achieve a mode of contact whereby the zone of contact increases in stepwise fashion in association with increasing load (increasing amount of displacement) under the action of contact-inducing load. Further reductions in shock and noise may be attained thereby. In particular, where the structure is one having the stopper mechanism constituted within the fluid chamber so that the pair of contact faces come into contact within a fluid, fluid will remain at the bottoms of the deepest grooves until the grooves and lands have completely collapsed through contact of the contact faces over their entire face, and this residual fluid can provide a lubricating action as well. Specifically, by means of this lubricating action, it is possible to achieve further reductions in noise, catching, and other problems. In this case, it will be yet more preferable for grooves of different depth to be formed parallel in an alternating pattern. The technical features may be more effectively attained thereby.

In the rubber vibration-damping device which pertains to the present invention, in preferred practice wherein the grooves and lands in the first contact portion and the second contact portion extend up to outside edges of the contact faces, and with the first contact portion and second contact portion in a state of contact with each other, the grooves and lands open onto outside peripheral portions of the contact faces. With such a mode, the grooves can be prevented from being covered and sealed off when the contact faces are in contact with one another.

### BEST MODE FOR CARRYING OUT THE INVENTION

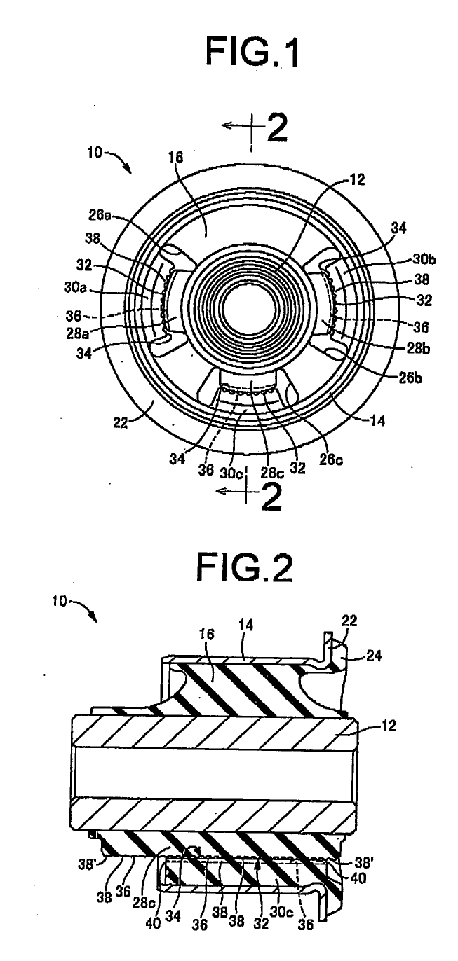

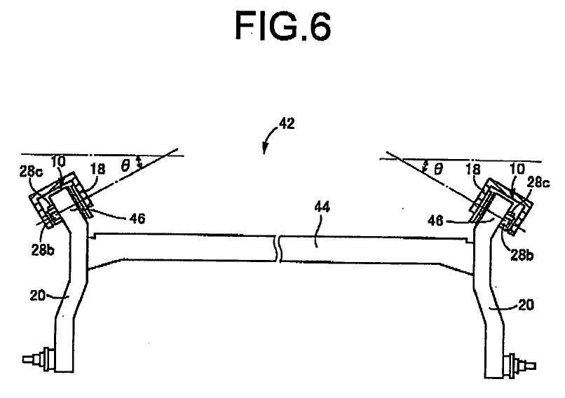

A fuller understanding of the invention will be provided through the following description of certain preferred embodiments of the invention. First, FIGS. 1-3 depict an automotive suspension bushing 10 by way of a first embodiment of the present invention. The suspension bushing 10 has a structure wherein an inner cylindrical metal member 12 serving as the first mounting member and an outer cylindrical metal member 14 serving as the second mounting member are positioned in opposition spaced apart from one another by a prescribed distance in the axis-perpendicular direction, and elastically coupled to one another by a main rubber elastic body 16 disposed between them. The inner cylindrical metal member 12 is then fastened to a mounting bracket 18 located on the vehicle body, as one of the components for vibration-absorbing connecting, while the outer cylindrical metal member 14 is fastened to a swing arm 20 in an automotive suspension, as the other component for vibration-absorbent connecting, providing vibration-damping linkage of the vehicle body and the automotive suspension (see FIG. 6).

To describe in greater detail, the inner cylindrical metal member 12 has a thick-walled, small-diameter tubular shape, and is fabricated using a rigid member of aluminum alloy, steel, or the like. The outer cylindrical metal member 14 is positioned diametrically outward from the inner cylindrical metal member 12.

The outer cylindrical metal member 14 has a thin-walled, large-diameter tubular shape, and is fabricated using a rigid member of aluminum alloy, steel, or the like. At one axial end of the outer cylindrical metal member 14 (in FIG. 2, the right end) there is integrally formed a flanged portion 22 that extends out in the axis-perpendicular direction. The axial dimension of the outer cylindrical metal member 14 is shorter than the axial dimension of the inner cylindrical metal member 12. The inner cylindrical metal member 12 is positioned diametrically inward from this outer cylindrical metal member 14, with the inner cylindrical metal member 12 and the outer cylindrical metal member 14 arranged so as to share roughly the same center axis. The two axial ends of the inner cylindrical metal member 12 project axially outward from the two open ends of the outer cylindrical metal member 14.

The main rubber elastic body 16 is disposed between the inner cylindrical metal member 12 and the outer cylindrical metal member 14. The main rubber elastic body 16 has a thick-walled tubular shape, the inside peripheral face of which is vulcanization bonded to the outside peripheral face of inner cylindrical metal member 12, and the outside peripheral face of which is vulcanization bonded to the inside peripheral face of the outer cylindrical metal member 14. That is, the main rubber elastic body 16 takes the form of an integrally vulcanization molded component that includes the inner cylindrical metal member 12 and the outer cylindrical metal member 14. A cushion rubber 24 integrally formed with the main rubber elastic body 16 is affixed against the flanged portion 22. A recess shaped so as to gouge axially inward is formed over portions at each of the two axial ends of the main rubber elastic body 16. This has the effect of reducing tensile stress of the main rubber elastic body 16 caused by relative displacement of the inner cylindrical metal member 12 and the outer cylindrical metal member 14.

In the main rubber elastic body 16, a first slit 26a and a second slit 26b are formed so as to be positioned in opposition to one another, to either side of the inner cylindrical metal member 12 in an axis-perpendicular direction representing the direction of input of principal vibration load (the left-right direction in FIG. 1). A third slit 26c is formed to one side of the inner cylindrical metal member 12 (the lower side in FIGS. 1 and 2), in a direction orthogonal to the direction of opposition of the first slit 26a and the second slit 26b. This first slit 26a, second slit 26b, and third slit 26c have generally fan-shaped cross section that gradually increases in length in the circumferential direction from the inner cylindrical metal member 12 towards the outer cylindrical metal member 14, and extend through the main rubber elastic body 16 in the axial direction as well as opening onto both axial end faces of the main rubber elastic body 16. The diametrical inside edges of the slits 26 are constituted by the outside peripheral face of the inner cylindrical metal member 12, while the diametrical outside edges of the slits 26 are constituted by the inside peripheral face of the outer cylindrical metal member 14. In the present embodiment, the first slit 26a and the second slit 26b are of substantially identical size, while the third slit 26c is slightly smaller than the first slit 26a and the second slit 26b; however, this arrangement should not be construed as limiting. This sets the spring ratio of two axis-perpendicular directions, namely, the axis-perpendicular direction lying the direction of opposition of the first slit 26a and the second slit 26b, and the axis-perpendicular direction orthogonal to this direction of opposition, and in which the third slit 26c lies.

The first through third slits 26a, 26b, 26c are respectively furnished with a pair of stopper rubbers composed of an inner cushion rubber 28a, 28b, 28c and an outer cushion rubber 30a, 30b, 30c. The inner cushion rubbers 28 and the outer cushion rubbers 30 are integrally formed with the main rubber elastic body 16. The main rubber elastic body 16, the inner cushion rubbers 28, and the outer cushion rubbers 30 are fabricated using natural rubber, butadiene rubber, or self-lubricating rubber, for example.

The inner cushion rubbers 28 are vulcanization bonded to the outside peripheral face of the inner cylindrical metal member 12 so as to project out from the inner cylindrical metal member 12 towards the outer cylindrical metal member 14, and extend in the axial direction of the bushing 10 with an unchanging, generally rectangular shaped cross section. The two axial ends of the inner cushion rubbers 28 extend into proximity with the ends of the inner cylindrical metal member 12 and are thereby positioned axially outward from the ends of the outer cylindrical metal member 14. The projecting distal edge faces 32 of the inner cushion rubbers 28 are curved at a curvature radius approximately equal to that of the outside peripheral face of the inner cylindrical metal member 12 and the inside peripheral face of the outer cylindrical metal member 14.

On the other hand, the outer cushion rubbers 30 are vulcanization bonded to the outside peripheral face of the outer cylindrical metal member 14 at the circumferential center portion of the slits 26 so as to project out from the outer cylindrical metal member 14 towards the inner cylindrical metal member 12, and extend in the axial direction of the bushing 10 with an unchanging, generally rectangular shaped cross section. The two axial ends of the outer cushion rubbers 30 extend into proximity with the ends of the outer cylindrical metal member 14. The projecting distal edge faces 34 of the outer cushion rubbers 30 are curved at a curvature radius approximately equal to that of the inside peripheral face of the outer cylindrical metal member 14 and the outside peripheral face of the inner cylindrical metal member 12.

The inner cushion rubbers 28 and the outer cushion rubbers 30 are positioned in opposition to one another in the slits 26.

In the present embodiment in particular, with regard to the width dimension of the inner and outer cushion rubbers 28, 30 in the circumferential direction of the bushing 10, the dimension of the outer cushion rubbers 30 is greater than that of the inner cushion rubbers 28. Also, the axial dimension of the outer cushion rubbers 30 is greater than the axial dimension of the inner cushion rubbers 28. As a result, in the circumferential direction of the bushing 10, the distal edge faces 34 of the outer cushion rubbers 30 will be larger than the distal edge faces 32 of the inner cushion rubbers 28, while in the axial direction of the bushing 10, the distal edge faces 32 of the inner cushion rubbers 28 will be larger than the distal edge faces 34 of the outer cushion rubbers 30.

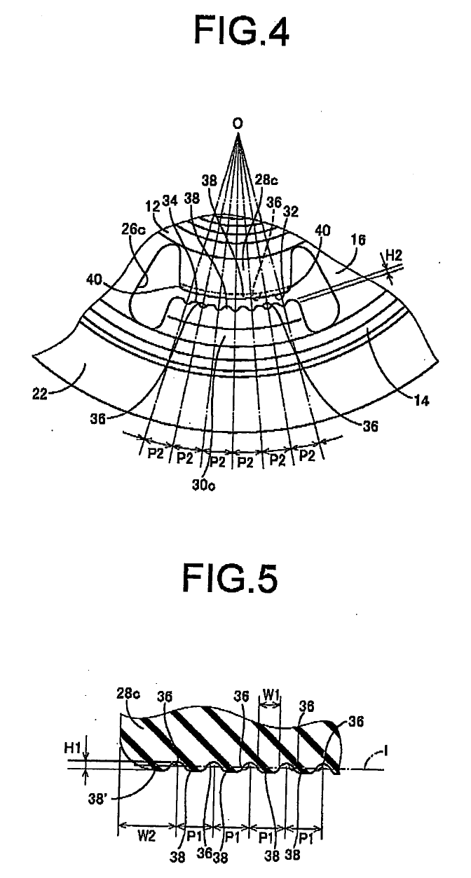

As shown in enlarged view in FIG. 4 or 5, the distal edge faces 32 of the inner cushion rubbers 28 and the distal edge faces 34 of the outer cushion rubbers 30 are furnished with grooves and lands 36, 38 composed of a plurality of grooves 36 and lands 38. The grooves and lands 36, 38 are integrally formed with the inner and outer cushion rubbers 23, 30, and hence with the main rubber elastic body 16. These grooves 36 and lands 38 are formed extending parallel to one another on each of the distal edge faces 32, 34 of the inner and outer cushion rubbers 28, 30, and in alternating fashion in a prescribed direction of extension of the distal edge faces 32, 34. In particular, the grooves and lands 36, 33 provided on the inner cushion rubbers 28 extend in mutually different directions from the grooves and lands 36, 38 provided on the outer cushion rubbers 30.

The plurality of grooves 36 and lands 38 on the inner cushion rubbers 28 extend with substantially unchanging cross section in one direction axis-perpendicular to the bushing 10 (in FIG. 4, left-right), and are positioned in an alternating parallel arrangement in the lengthwise direction of the distal edge faces 32 of the inner cushion rubbers 28 parallel to the axial direction of the bushing 10. The grooves 36 and lands 38 are disposed on a continuous parallel arrangement with no gaps between them, with side walls of the grooves 36 connecting smoothly with the side walls of the lands 38.

Viewed in cross section along the axial direction of the bushing 10, the cross section of the grooves 36 on the distal edge face 32 of the inner cushion rubber 28 is of generally semicircular shape opening outwardly at the distal edge face 32, while the cross section of the lands 38 is generally trapezoidal in shape extending outwardly from the distal edge face 32. The distal edges of the lands 38 are therefore flat surfaces.

In the present embodiment, with the distal edge face 32 viewed in cross section along the axial direction of the bushing 10, the cross sectional area of the lands 38 is greater than the cross sectional area of the grooves 36, with respect to a reference line: 1 connecting the intermediate positions between the deepest points of the grooves 36 and the apical points of the lands 38. The depth dimension of the grooves 36, which is equivalent to the distance in the axis-perpendicular direction separating the deepest point of the groove 36 from the reference line: 1, is approximately the same as the height dimension of the lands 38, which is equivalent to the distance in the axis-perpendicular direction separating the apical point of the land 38 from the reference line 1.

In preferred practice, the combined value: H1 of the groove 36 depth dimension and the land 38 height dimension will be 0.3 mm or greater. The reason is that if the value: H1 is less than 0.3 mm, it will be difficult to achieve the intended cushioning action and noise reducing effect. Furthermore, in consideration of the desired noise reducing effect, as well as installation space and so on, the width dimension: W1 of the lands 38 will preferably be no more than 5 mm. Moreover, the pitch; P1 of a land 38 situated between the deepest parts of a pair of neighboring grooves 36, 36 will preferably be 1.1 mm or greater. If the land 38 pitch: P1 is less than 1.1 mm, it will be difficult to attain satisfactory durability of the lands 38, and there is furthermore a risk that the lands 38 on either of the two distal edge faces 32, 34 will become caught deep in the grooves 36 of the other, when the two distal edge faces 32, 34 of the inner cushion rubbers 28 and the outer cushion rubbers 30 come into contact, making it difficult to achieve intended cushioning action and noise reducing effect.

On the other hand, the plurality of grooves 36 and lands 38 on the outer cushion rubbers 30 extend with substantially unchanging cross section in the lengthwise direction of the distal edge faces 34 of the outer cushion rubbers 30 parallel to the axial direction of the bushing 10, and are positioned in an alternating parallel arrangement in one direction axis-perpendicular to the bushing 10 (in FIG. 4, left-right). In particular, the grooves and lands 36, 38 of the outer cushion rubbers 30 pertaining to the present embodiment have approximately the same shape and size as the grooves and lands 36, 38 of the inner cushion rubbers 28. Specifically, the distal edges of the lands 38 are flat in shape. The combined value: H2 of the groove 36 depth dimension and the land 38 height dimension is approximately equal to the combined value: H1 of the groove 36 depth dimension and the land 38 height dimension in the inner cushion rubbers 28, and the width dimension of the lands 38 is approximately equal to the width dimension: W1 of the lands 38 of the inner cushion rubbers 28. Since the grooves and lands 36, 38 of the outer cushion rubbers 30 extend in the axial direction of the bushing 10 and are arranged in parallel along the direction of curvature of the curving distal edge face 34, in the present embodiment, the pitch: P2 of a land 38 situated between the deepest parts of a pair of neighboring grooves 36, 36, represented by a center angle centered on the center O of the bushing 10; will preferably be 5 degrees or greater.

As a result, the grooves and lands 36, 38 of the inner cushion rubbers 28 and the grooves and lands 36, 38 of the outer cushion rubbers 30 face one another in mutually intersecting directions; in the present embodiment in particular, the angle of intersection thereof is 90 degrees. While the angle of intersection of the grooves and lands 36, 38 of the inner cushion rubbers 28 and the grooves and lands 36, 38 of the outer cushion rubbers 30 is not limited in any particular way, in preferred practice it will be between 45 and 135 degrees, more preferably 90 degrees as in the present embodiment.

Among the grooves and lands 36, 38, a land 38 is situated at each end of the distal edge faces 32, 34 of the inner and outer cushion rubbers 28, 30, with the edge of the land 38 lying towards the outside in the width direction (in FIG. 5, the left edge) having a shape that curves at a radius of curvature greater than the sum value: H1 of the groove 36 depth dimension and the land 38 height dimension, and greater than the land 38 height dimension, and that connects smoothly with the side wall of the cushion rubber 28, 30. In the present embodiment, the width dimension: W2 of the land 38′ provided with such a curved edge is greater than the pitch: P1, P2 of the lands 38 provided in the medial portions of the distal edge faces 32, 34, for example, a multiple of 1.2 of the pitch: P1, P2.

On the distal edge faces 32, 34 of the inner and outer cushion rubbers 28, 30, the edges lying in the direction orthogonal to the edge provided with the land 38′, in other words the axial edges of the grooves and lands 36, 38, each have a curving portion 40 formed thereon. Viewed in cross section in the direction of extension of the grooves and lands 36, 38 of the distal edge faces 32, 34, the curving portion 40 has a shape that at the inside edge connects smoothly with the edge of the groove 36 or land 38, and that moving towards the outside edge from the inside edge, curves at a radius of curvature greater than the sum value: H1 (H2) of the groove 36 depth dimension and the land 38 height dimension, and greater than the land 38 height dimension, with the outside edge connecting smoothly with the side wall of the cushion rubber 28, 30. As will be apparent from the preceding discussion, the height dimension of the grooves and lands 36, 38 pertaining to the present embodiment is the sum value: H1 (H2) of the groove 36 depth dimension and the land 38 height dimension.

During integral vulcanization molding of the main rubber elastic body 16 that includes the inner cylindrical metal member 12 and the outer cylindrical metal member 14, the grooves and lands 36, 38 and curving portions 40 provided to the distal edge face 32 of the inner cushion rubbers 28, and the grooves and lands 36, 38 and curving portions 40 provided to the distal edge face 34 of the outer cushion rubbers 30 will be positioned spaced apart from each other by a prescribed distance in the diametrical direction as shown in FIG. 4. The outer cylindrical metal member 14 will then be subjected to a diameter-reducing process such as 360 degree reduction so that the grooves and lands 36, 38 and curving portions 40 of the inner cushion rubbers 28, and the grooves and lands 36, 38 and curving portions 40 of the outer cushion rubbers 30 are now held in a state of contact with one another. Specifically, as shown in FIGS. 1 and 2, the distal edge faces of the lands 38 disposed on the distal edge faces 32 of the inner cushion rubbers 28 and the distal edge faces of the lands 38 disposed on the distal edge faces 34 of the outer cushion rubbers 30 will be held in mutually orthogonally contact with one another.

The automotive suspension bushing 10 having such a structure may be employed, for example, as automotive suspension in a rear trailing arm suspension 42.

The rear trailing arm suspension 42 has a structure with a swing arm 20 extending in the vehicle front-back direction (in FIG. 6, the vertical direction) affixed to each of the two ends of a torsion beam 44 that extends in the vehicle width direction (in FIG. 6, the left-right direction), and a tubular fastener portion 46 disposed on the front end of each swing arm 20. In particular, in the present embodiment the fastener portions 46 are inclined by a prescribed angle: θ towards the rear of the vehicle from the vehicle width direction (downward in FIG. 6).

The suspension bushing 10 is secured with the end on the opposite side from its flanged portion 22 press-fit into the fastener portion 46 of each of the swing arms 20. The mounting bracket 18 on the vehicle body side is disposed sandwiching either end of the inner cylindrical metal member 12 which projects outward from the fastener portion 46, and a fastener bolt, not shown, is passed through the inner cylindrical metal member 12 to bolt it in place. In particular, the suspension bushing 10 is positioned with the direction of opposition of the first slit 26a and the second slit 26b aligned with the vehicle vertical direction, and with the third slit 26c facing the front of the vehicle. Vibration-damping linkage of the rear trailing arm suspension 42 and the vehicle body is produced thereby; in the present embodiment in particular, in the installed state in the vehicle, the suspension bushing 10 is positioned with the center axis of the bushing 10 inclined by a prescribed angle: θ towards the rear of the vehicle from the vehicle width direction.

With the suspension bushing 10 installed in the above manner, when vibration load is input in the vehicle vertical direction across the inner cylindrical metal member 12 and the outer cylindrical metal member 14, the amount of relative displacement of the inner cylindrical metal member 12 and the outer cylindrical metal member 14 will be limited in cushionwise manner by means of contact of the metal members 12, 14 via the outer cushion rubber 30 and the inner cushion rubber 28 provided in the first slit 26a or the second slit 26b. When vibration load is input in the vehicle front-back direction across the inner cylindrical metal member 12 and the outer cylindrical metal member 14, the amount of relative displacement of the inner cylindrical metal member 12 and the outer cylindrical metal member 14 will be limited in cushionwise manner by means of contact of the metal members 12, 14 via the outer cushion rubber 30c and the inner cushion rubber 28c provided in the third slit 26c. As will be apparent from the above, in the present embodiment, the stopper mechanism for limiting in cushionwise manner the amount of relative displacement of the inner cylindrical metal member 12 and the outer cylindrical metal member 14 includes the inner cushion rubbers 28 and the outer cushion rubbers 30. The pair of contact faces in the stopper mechanism are constituted to include the distal edge faces 32, 34 of the inner and outer cushion rubbers 28, 30.

By positioning the suspension bushings 10 so that they are inclined by prescribed angle towards the rear from the vehicle width direction, when vibration load is input in the vehicle front-back direction or vehicle vertical direction and the swing arms 20 undergo swinging motion, the load will be input across the inner cylindrical metal member 12 and the outer cylindrical metal member 14 in a shearing direction which represents a combination of a twisting direction and the substantially diametrical direction of the bushing 10. Thus, there is a possible problem of noise due to scraping displacement, occurring when the distal edge faces 32 of the inner cushion rubbers 28 and the distal edge faces 34 of the outer cushion rubbers 30 experience relative displacement in the shearing direction while in contact with one another, as in the present embodiment.

Accordingly, in the present embodiment, grooves and lands 36, 38 for contacting one another have been provided to the inner and outer cushion rubbers 28, 30, with the grooves and lands 36, 38 of the inner and outer cushion rubbers 28, 30 contacting one another in generally orthogonal directions, thereby effectively minimizing the surface area of the contacting portions of the two distal edge faces 32, 34.

Moreover, by positioning the grooves and lands 36, 38 of the two distal edge faces 32, 34 in mutually orthogonal directions, it is possible to effectively prevent the lands 38 of one of the two distal edge faces 32, 34 from becoming caught in the grooves 36 of the other, so that a state of stable contact of the two distal edge faces 32, 34 may be achieved. Consequently, it will be possible to avoid mechanical catching in the event that the two distal edge faces 32, 34 experience scraping displacement, such as can occur with small projections such as granulated projections or independent projections of conventional design.

It is possible thereby to improve the durability of the grooves and lands 36, 38 and hence of the inner cushion rubbers 28 and the outer cushion rubbers 30, as well as to reduce with sufficient effectiveness noise caused by scraping displacement or catching.

Moreover, in the present embodiment, on the two distal edge faces 32, 34, curving portions 40 larger than the projecting height of the lands 38 are provided at the edges of the outer cushion rubber 30 distal edge faces 34 that are smaller (narrower) in the axial direction of the bushing 10; and similar curving portions 40 are provided at the edges of the inner cushion rubber 28 distal edge faces 32 that are smaller (narrower) in the circumferential direction of the bushing 10. By so doing, it is possible to prevent the edges of one of the distal edge faces 32, 34 from becoming caught in the grooves 36 of the other of the distal edge faces 32, 34, or from catching on the lands 38 during scraping displacement of the distal edge faces 32, 34. The noise reducing effect and durability of the grooves and lands 36, 38 and the cushion rubbers 28, 30 may be more advantageously realized thereby.

While the present invention has been shown hereinabove through a certain preferred embodiment, the invention is in no wise limited to the specific disclosure in the embodiment, and various changes, modifications, and improvements thereto will be apparent to the skilled practitioner of the art. Insofar as such embodiments do not depart from the spirit of the present invention, they shall be considered to lie within the scope of the invention.

For example, the shape, size, structure, and other qualities of the grooves and lands 36, 38 are not limited to those taught herein by way of example.

Specifically, whereas in the preceding embodiment, the grooves and lands 36, 38 of the inner cushion rubbers 28 and the outer cushion rubbers 30 are substantially identical in shape, size, and structure, they could differ instead. For example, the plurality of grooves 36 or lands 38 all of approximately identical shape and size provided on the distal edge faces 32, 34 of each of the cushion rubbers 28, 30 could instead differ in size and/or shape. Moreover, the height dimension of the lands 38 or depth dimension of the grooves 36 disposed on either of the distal edge faces 32, 34 of the inner cushion rubbers 28 and the outer cushion rubbers 30 may differ from the height dimension of the lands 38 or depth dimension of the grooves 36 disposed on the other. Furthermore, the grooves 36 or lands 38 may have cross sections, viewed orthogonal to the direction of extension thereof, that are respectively rectangular, triangular, or circular in shape; nor is it always necessary for the distal edges of the lands 38 to be flat surfaces.

The curving portions 40 provided to the edges of the distal edge faces 32, 34 are not an essential element.

In the preceding embodiment, the stopper mechanism is constituted so as to include the inner cushion rubbers 28 and the outer cushion rubbers 30 composed of rubber material integrally formed with the main rubber elastic body 16, it would be possible to instead form the stopper mechanism, for example, using hard members of resin material or the like, by forming stopper rubbers so as to cover the distal edge faces of the hard members, and forming a plurality of grooves and lands in the stopper rubbers.

In the preceding embodiment, there was given a specific example of application in a suspension bushing 10 in which, for reasons relating inter alia to the manufacturing process, the outer cylindrical metal member 14 is subjected to a diameter constricting process with the distal edge faces 32 of the inner cushion rubbers 28 and the distal edge faces 34 of the outer cushion rubbers 30 spaced apart from one another in the diametrical direction, but in which when installed in an vehicle, the distal edge faces 32 of the inner cushion rubbers 28 and the distal edge faces 34 of the outer cushion rubbers 30 are maintained in contact with one another. However, the present invention is not limited to this type of suspension bushing 10, and could instead be implemented, for example, in a suspension bushing furnished with a stopper mechanism wherein the inner cushion rubbers and the outer cushion rubbers are spaced apart in the direction of principal vibration input, and when installed in an vehicle, the distal edge faces of the inner cushion rubbers and the outer cushion rubbers come into contact in an impinging manner.

The present invention is not limited to a rubber vibration-damping device of cylindrical design as described herein by way of example, and could also be implemented in rubber vibration-damping devices of so-called bowl type, such as those taught in JP-U-62-185944 and JP-U-3-59544, for example.

Moreover, the scope of implementation of the present invention is not limited to suspension bushings, and would also be effective as a rubber vibration-damping device in an automotive engine mounting, body mounting, or diff mounting, or in various non-automotive devices.

Furthermore, while the preceding embodiment described a specific example of implementation in an automotive suspension bushing 10 of solid type in which the inner cylindrical metal member 12 and the outer cylindrical metal member 14 are simply elastically coupled by the main rubber elastic body 16, there is no limitation to such an arrangement, and it would be possible to instead implement the invention, for example, in a suspension bushing of liquid type such as that disclosed in JP-A-8-72518, in which a first mounting metal member serving as the first mounting member and a second metal member serving as the second mounting member are elastically coupled by a main rubber elastic body, a fluid chamber having a non-compressible fluid sealed within is provided, and stopper rubbers are disposed within the fluid chamber.

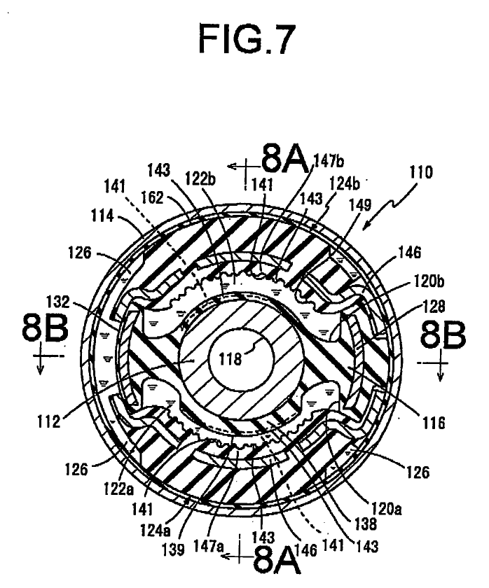

Another embodiment of the present invention implemented in a suspension bushing of liquid type will be described below with reference to FIGS. 7-19.

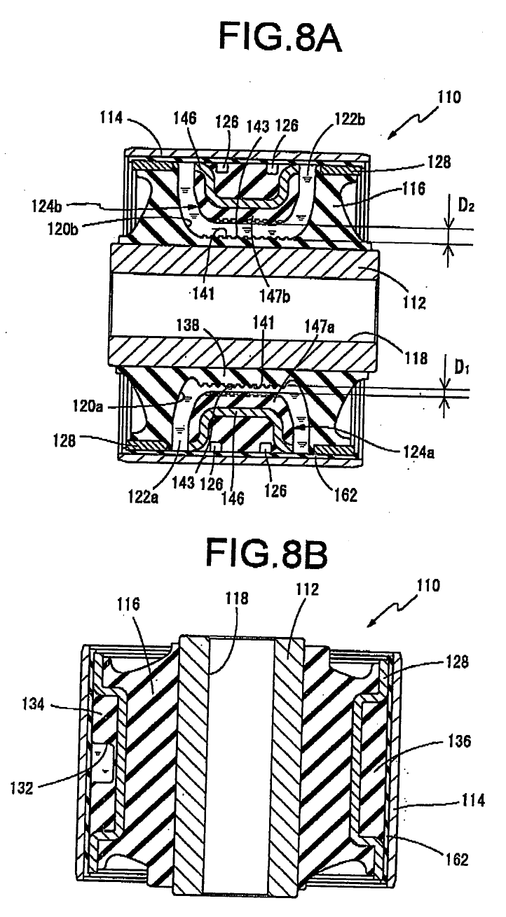

First, FIGS. 7 and 8 depict, in transverse sectional view and longitudinal sectional view respectively, an automotive suspension bushing 110 as a second embodiment of the rubber vibration-damping device according to the present invention. The suspension bushing 110 has a structure that includes an inner cylindrical metal member 112 serving as a shaft member, and an outer cylindrical metal member 114 positioned concentrically around the inner cylindrical metal member 112 and spaced apart therefrom by a prescribed distance outward in the diametrical direction (axis-perpendicular direction), serving as an outer cylindrical member; the inner cylindrical metal member 112 and the outer cylindrical metal member 114 are elastically coupled by means of a main rubber elastic body 116 interposed between the metal members 112, 114.

The suspension bushing 110 is designed to be disposed in a mounting component for mounting the suspension arm on the body, by means of inserting and fastening a support post (not shown) on the suspension arm into an inner hole 118 provided in the inner cylindrical metal member 112, while securing externally fitted onto the outer cylindrical metal member 114 a cylindrical arm eye (not shown) that is provided on the vehicle body. In this installed state, vibration absorbing properties are attained with respect to vibration (load) input primarily in the diametrical direction (axis-perpendicular direction), which is the vertical direction in FIG. 7.

In the suspension bushing 110 of the present embodiment, the main rubber elastic body 116 is provided to either side of the inner cylindrical metal member 112 in the diametrical direction with a first pocket portion 120a and a second pocket portion 120b that, particularly in the installed state, will be respectively situated on the side from which load (vibration) is input during initial or subsequent acceleration of the vehicle (the lower side in FIG. 7), and on the side from which load (vibration) is input during braking (the upper side in FIG. 7); the openings of the pair of first and second pocket portions 120a, 120b are covered by the outer cylindrical metal member 114. By means of this arrangement there are formed a first fluid chamber 122a and a second fluid chamber 122b having a non-compressible fluid sealed therein, positioned to either side in the direction of input of vibration load in the installed state at locations corresponding to the placement of the first and second pocket portions 120a, 120b. The openings of the first and second pocket portions 120a, 120b which provide the first and second fluid chambers 122a, 122b are respectively bridged in their circumferential direction by a first orifice member 124a and a second orifice member 124b of thick arcuate shape overall. The first and second orifice members 124a, 124b and the outer cylindrical metal member 114 form orifice passages 126 that pass through the first and second fluid chambers 122a, 122b.

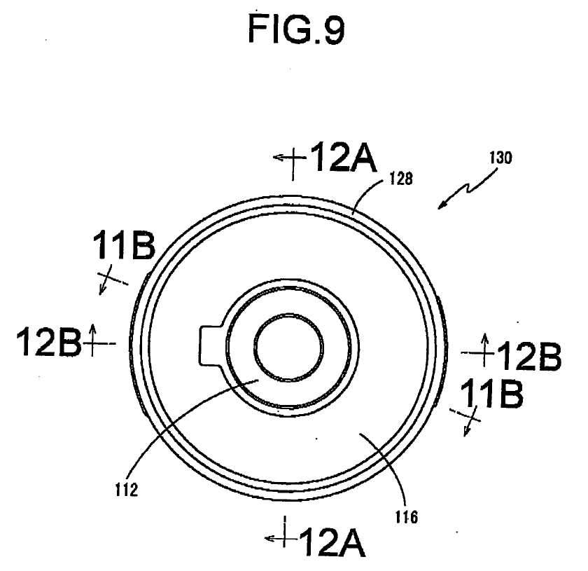

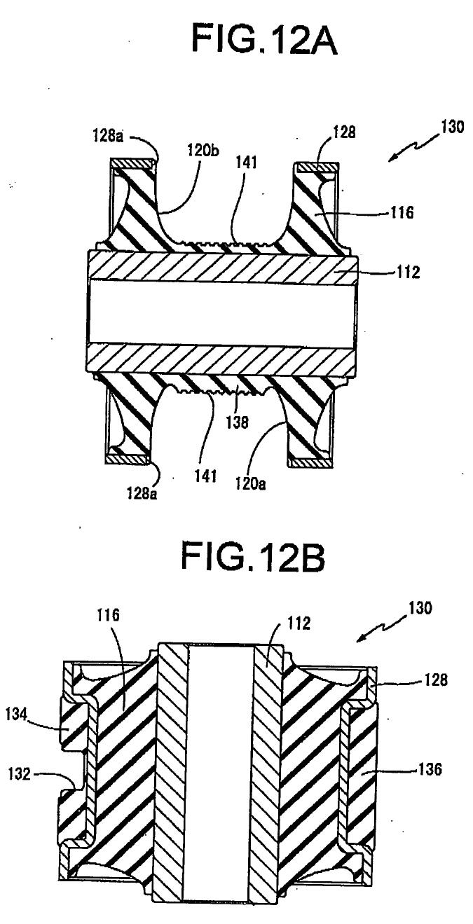

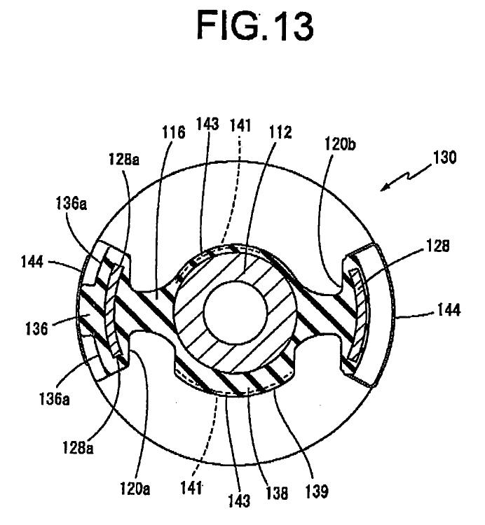

To describe in greater detail, as depicted in FIGS. 9-13, the inner cylindrical metal member 112 and the main rubber elastic body 116, together with a metal sleeve 128 serving as a intermediate sleeve, are constituted as an integrally vulcanization-molded part 130. That is, as will be understood from the drawings, the inner cylindrical metal member 112 of thick-walled, small-diameter cylindrical shape, and the metal sleeve 128 disposed spaced apart diametrically outward therefrom, are connected by the main rubber elastic body 116 through an integral vulcanization molding process with the main rubber elastic body 116 to produce the integrally vulcanization-molded part 130. As will be apparent from FIGS. 12 and 13, the metal sleeve 128 has a shouldered cylinder shape whose middle section in the axial direction is a small diameter portion and whose two end sections are large diameter portions, and in whose cylinder wall a pair of axis-symmetrically disposed window portions 128a, 128a have been produced by cutting out large rectangular shapes.

In the integrally vulcanization-molded part 130 composed of the inner cylindrical metal member 112, the metal sleeve 128, and the main rubber elastic body 116, the first and second pocket portions 120a, 120b that open onto the outside peripheral face through the window portion 128a of the metal sleeve 128 are formed symmetrically based on the placement pattern described above by means of this integral vulcanization molding process. Of this pair of pocket portions 120a, 120b, the first pocket portion 120a which, with the suspension bushing 110 installed on the vehicle, is located on the side from which vibration load is input during initial or subsequent acceleration of the vehicle (the lower side in FIG. 13) has on its floor an inner cushion rubber 138 of prescribed height serving as a second contact portion, integrally formed with the main rubber elastic body 116 (FIG. 7).

As with the distal edge face 32 of the inner cushion rubber 28 in the first embodiment discussed previously, the distal edge face 139 serving as the contact face of the inner cushion rubber 138 is furnished with grooves and lands 141, 143 composed of a plurality of grooves 141 and lands 143. These grooves and lands 141, 143 are of similar construction to the grooves and lands 36, 38 in the first embodiment. Grooves and lands 141, 143 of similar construction are formed on the floor of the second pocket portion 120b as well.

In the integrally vulcanization-molded part 130, in one of the small diameter portions that are formed by rubber elastic material extended from the main rubber elastic body 116 and bifurcated by the two window portions 128a, 128a of the metal sleeve 128, a channel 132 of prescribed width connecting the first and second pocket portions, 120a, 120b is disposed in the circumferential direction and opening on the outside peripheral face. Specifically, the rubber elastic material extended out onto the outside peripheral face of this one small diameter portion constitutes a channel-forming rubber elastic body 134, in which is formed the channel 132 of prescribed width extending in the circumferential direction.

Meanwhile, the outside peripheral face of the other separated small diameter portion of the metal sleeve 128 has a partition wall 136 similarly constituted of rubber elastic material extended from the main rubber elastic body 116 and partitioning the first and second pocket portions 120a, 120b, as well as latching recesses 136a, 136a of prescribed length, respectively disposed to either side of the partition wall 136 in the circumferential direction, and adapted to latch with a latching portion 148 provided to one circumferential end of an orifice member 124, to be discussed later.

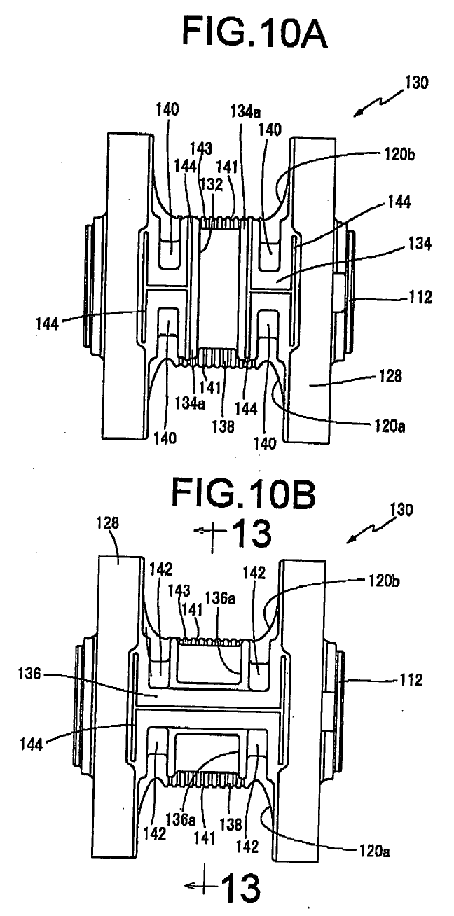

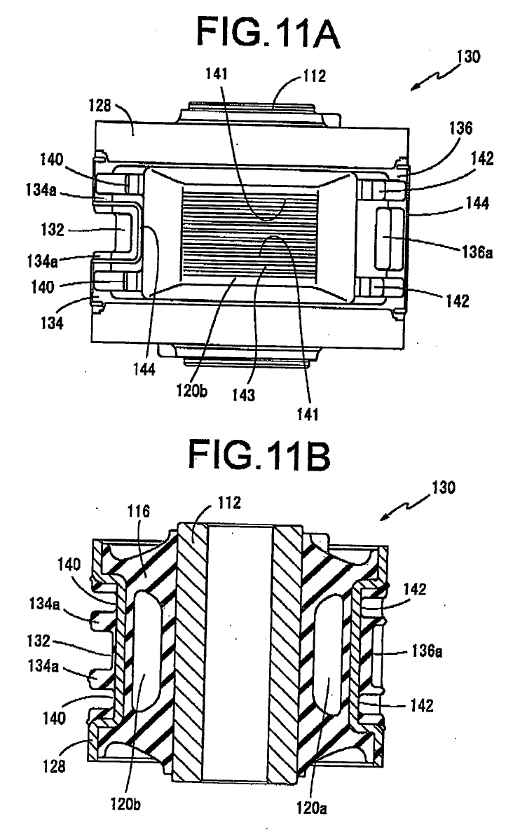

As shown in FIGS. 9-11, the channel-forming rubber elastic body 134 containing the channel 132 is provided with lightening slots 140, 140 of prescribed length extending in the circumferential direction along the channel 132 in portions of the channel-forming rubber elastic body 134 situated to the side of the channel 132, with the lightening slots 140, 140 respectively disposed to either side of the channel 132 and having approximately the same depth as the channel 132. The lightening slots 140, 140 situated to either side of the channel 132 originate at the two circumferential edges of the channel-forming rubber elastic body 134 and open into the corresponding pocket portions 120, as well as opening onto the outside peripheral face. The partition wall 136 of prescribed thickness disposed on the outside peripheral face of the small diameter portion of the metal sleeve 128 is also provided respectively with second lightening slots 142, 142 that extend from the first and second pocket portions 120a, 120b so as to be situated to either side of the latching recess 136a (see FIG. 10B and FIG. 11).

As will be apparent from FIGS. 10 and 11 for example, sealing of the pocket portions 120, the channel 132, and so on is provided through a continuous seal bead 144 of semicircular cross section disposed integrally on the outside peripheral face of the integrally vulcanization-molded part 130 which is urged into contact against the inside peripheral face of the outer cylindrical metal member 114.

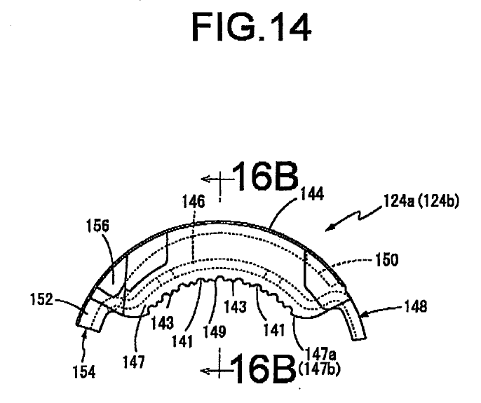

Meanwhile, as illustrated in FIGS. 14-17, the orifice members 124a, 124b which form the orifice passages 126 next to the inside peripheral face of the outer cylindrical metal member 114 are each composed of a vulcanization-molded rubber elastic body of prescribed thickness having generally arcuate shape overall, within which has been embedded a plate-shaped core 146 for reinforcing purposes, fabricated to inside peripheral shape by means of press-molding. In such a vulcanization-molded rubber elastic body orifice member 124, the rubber portion thereof that is located over the inside peripheral face of the core 146 and that provides the inside peripheral face of the orifice member 124 constitutes an outer cushion rubber 147 serving as a first contact portion having prescribed thickness. Here, favorable examples of the elastic body constituting the entire orifice member 124 inclusive of the outer cushion rubbers 147 are a blend of NR (natural rubber) and SBR (styrene butadiene rubber), a high-attenuation rubber composed of a blend of NR and BR (butadiene rubber), or a self-lubricating rubber composed of NR, SBR, BR or other rubber material containing prescribed amounts of fatty acid amide, polyethylene glycol surfactant, or the like. In the present embodiment, the inner cushion rubber 138 and the outer cushion rubbers 147 together constitute the stopper mechanism.

In the present embodiment, grooves and lands 141, 143 composed of a plurality of grooves 141 and lands 143 are provided on the distal edge face 149 which constitutes the contact face of the outer cushion rubber 147.

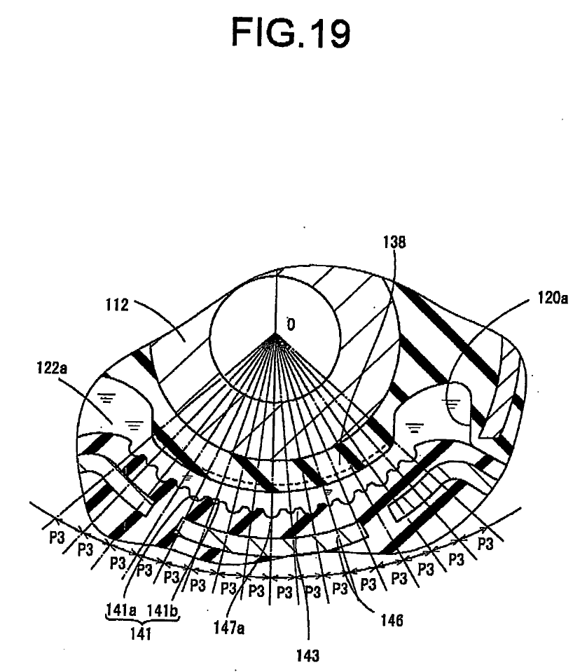

As shown in enlarged view in FIG. 19, the distal edge faces 149 of the outer cushion rubbers 147 are each provided with grooves and lands 141, 143 composed of a plurality of grooves 141 and lands 143. These grooves and lands 141, 143 are each integrally formed with the outer cushion rubber 147. These grooves 141 and the lands 143 extend parallel to one another on the distal edge face 149 of the outer cushion rubbers 147, and are formed in alternating fashion in a prescribed direction of extension of the distal edge face 149. In particular, the grooves and lands 141, 143 provided on the outer cushion rubbers 147 extend in a different direction from the grooves and lands 141, 143 provided on the inner cushion rubber 138 and on the main rubber elastic body 116.

Here, the plurality of grooves 141 and lands 143 on the outer cushion rubbers 147 extend with substantially unchanging cross section in the lengthwise direction of the distal edge face 149 of the outer cushion rubber 147 parallel to the axial direction of the bushing 110, and are positioned in an alternating parallel arrangement in one direction axis-perpendicular to the bushing 10 (in FIG. 19, left-right).

In this case, the grooves and lands 141, 143 of the outer cushion rubbers 147 pertaining to the present embodiment differ in shape from the grooves and lands 141, 143 formed on the inner cushion rubber 138. Specifically, viewed in cross section in the diametrical direction of the bushing 110 on the distal edge face 149 of the outer cushion rubber 147, the grooves 141 are formed by means of forming generally semicircular slots that extend in from the distal edge face 149, while lands 143 whose distal ends are flat are produced in areas where grooves 141 have not been formed.

The plurality of grooves 141 are composed of two types of grooves that mutually differ in their depth dimension, formed in alternating fashion. Specifically, the grooves 141 are composed of large-diameter grooves 141a whose semicircular cross section has a large diameter dimension and whose depth dimension is greater, and small-diameter grooves 141b whose semicircular cross section has a small diameter dimension and whose depth dimension is smaller. In the present embodiment, the large-diameter grooves 141a have a semicircular cross section diameter dimension that is approximately twice the semicircular cross section diameter dimension of the small-diameter grooves 141b. Thus, the large-diameter grooves 141a are formed with a depth dimension twice that of the small-diameter grooves 141b, from the distal edge face 149 of the outer cushion rubber 147.

The grooves and lands 141, 143 of the outer cushion rubbers 147 extend in the axial direction of the bushing 110 as well as in an alternating arrangement in the direction of curvature of the curved distal edge face 149; furthermore, the large-diameter grooves 141a and small-diameter grooves 141b of generally semicircular cross section constituting the plurality of grooves 141 are arranged in alternating fashion. In the present embodiment, the pitch: P3 at which the deepest parts of respective grooves 141 are formed, represented by a center angle centered on the center: O of the bushing 110; will preferably be 6 degrees or greater.

As a result, the grooves and lands 141, 143 of the inner cushion rubber 138 and the grooves and lands 141, 143 of the outer cushion rubbers 147 face one another in mutually intersecting directions; in the present embodiment in particular, the angle of intersection thereof is 90 degrees. While the angle of intersection of the grooves and lands 141, 143 of the inner cushion rubber 138 and the grooves and lands 141, 143 of the outer cushion rubbers 147 is not limited in any particular way, in preferred practice it will be between 45 and 135 degrees, more preferably 90 degrees as in the present embodiment.

Among the grooves and lands 141, 143, a land 143 is situated at each end of the distal edge faces 149 of the outer cushion rubbers 138, 147.

The grooves and lands 141, 143 disposed on the distal edge faces 149 of the outer cushion rubbers 147, and the grooves and lands 141, 143 disposed on the distal edge face 139 of the inner cushion rubber 138 and on the main rubber elastic body 116 are positioned as shown in FIG. 7, spaced apart by prescribed distance in the circumferential direction with their respective grooves and lands 141, 143 positioned juxtaposed in a mutually intersecting condition.

The orifice member 124 formed by the outer cushion rubber 147 in this way has the aforementioned core 146 embedded within it. The core 146 is disposed so as to project from both ends of the arcuate shaped orifice member 124, with one of the projecting portions constituting a latching portion 148, when covered over its entire face by a rubber elastic body extending from the main body of the orifice member 124; this latching portion 148 mates with the latching recess 136a provided in the partition wall 136 to effect latching.

On the plate shape core 146 projecting from the other end of the arcuate shaped orifice member 124 there is disposed an orifice slot 150 of prescribed depth formed on the outside peripheral face of the orifice member 124; upright elastic body walls integrally extending up from the elastic body that makes up the body of the orifice member 124 constitute two sidewall portions 152, 152 integrally formed at the two sides of the end of the core 146 and forming the end of the orifice slot 150. These two sidewall portions 152, 152 and the projecting end of the core 146 together form a gutter type projecting portion 154, with the orifice slot 150 opening out at the distal end of the gutter type projecting portion 154.

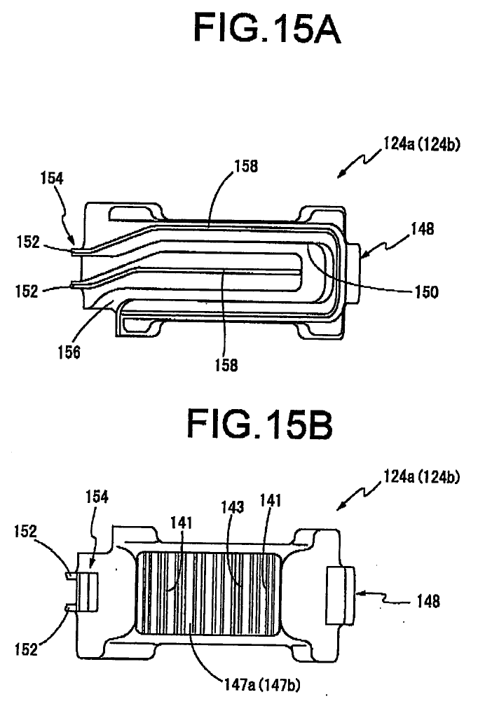

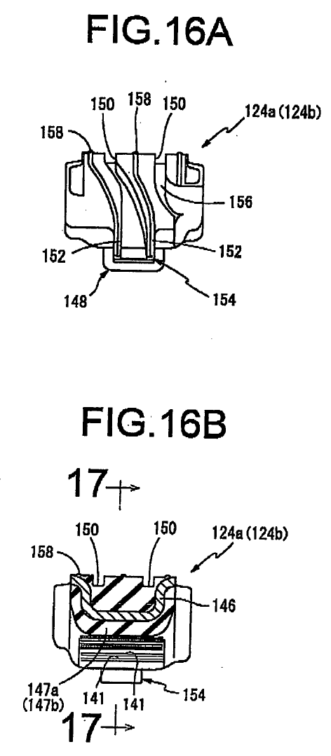

As shown in FIG. 15A, this orifice slot 150 is constituted by a single slot disposed on the outside peripheral face of the orifice member 124 and doubling back in a U-turn configuration; one end of the slot leads into the gutter type projecting portion 154 while the other end opens to the side to constitute a pocket portion communication opening 156 which, as will be discussed later, is designed to communicate with the pocket portion 120 where the orifice member 124 is situated. As will be apparent from FIG. 15A and FIG. 16A, the orifice slot 150 which extends into the gutter type projecting portion 154 gradually increases in width moving towards the gutter type projecting portion 154 from the portion thereof situated over the body of the orifice member 124, 150 that the width of the orifice slot 150 in at least the section thereof formed in the gutter type projecting portion 154 is greater than that of the section on the body side, and the flow passage cross sectional area thereof is larger.

On the outside peripheral face of the orifice member 124 there are integrally disposed seal beads 158 positioned on the upper faces of the walls to either side of the orifice slot 150, with a view to improving sealing of the orifice slot 150. Furthermore, the end face of section of the orifice member 124 girdling the gutter type projecting portion 154, in other words, the end face of the orifice member 124 body on the side thereof at which the gutter type projecting portion 154 is disposed, is formed in a shape that corresponds to the end face around the channel 132 situated in the channel-forming rubber elastic body 134 of the integrally vulcanization-molded part 130, into which the gutter type projecting portion 154 will be fitted; by assembling the components with these two end faces placed in contact, it will be possible to improve sealing action between the orifice member 124 and the channel-forming rubber elastic body 134.

Once the integrally vulcanization-molded part 130 discussed earlier has been assembled using the first orifice member 124a and the second orifice member 124b with the structures discussed above, the outer cylindrical metal member 114, with a seal rubber layer 162 of prescribed thickness formed on its inside peripheral face, is affixed externally fitting onto the assembly to obtain the suspension bushing 110 like that shown in FIGS. 7 and 8; to do so, first, the first and second orifice members 124a, 124b are assembled so as to respectively bridge in the circumferential direction the openings of the first and second pocket portions 120a, 120b situated in the main rubber elastic body 116 section of the integrally vulcanization-molded part 130 and to cover the openings of the pocket portions 120a, 120b, and so that the outer cushion rubbers 147a, 147b are respectively positioned in opposition to the floors of the pocket portions 120a, 120b.

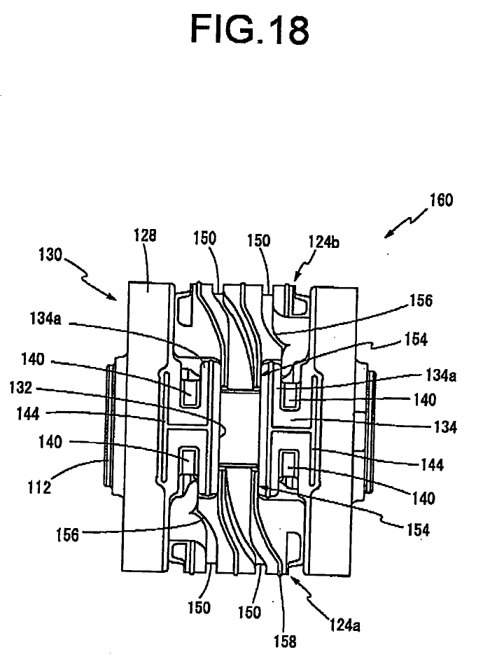

More specifically, the latching portion 148 disposed on one end of each orifice member 124 is latched in the latching recess 136a disposed on the partition wall 136 situated on one of the small diameter portions of the metal sleeve 128 in the integrally vulcanization-molded part 130, while the gutter type projecting portion 154 disposed on the other circumferential end of each orifice member 124 is positioned inserted within the channel 132 which has been formed in the channel-forming rubber elastic body 134 disposed on the other small diameter portion of the metal sleeve 128, thereby forming an assembly 160 constructed by attaching the first and second orifice members 124a, 124b to the integrally vulcanization-molded part 130, as illustrated in FIG. 18.

As shown in FIG. 18, in this assembly 160, the distance by which the gutter type projecting portion 154 disposed at the end of the orifice slot 150 of each orifice member 124 is inserted into the channel 132 is exceeded in length by the circumferential length of the lightening slots 140, 140 situated to either side thereof. Moreover, by means of attaching the first and second orifice members 124a, 124b to the integrally vulcanization-molded part 130, the orifice slots 150, 150 of the first and second orifice members 124a, 124b are connected via the channel 132, while also communicating with the corresponding first and second pocket portions 120a, 120b through the pocket portion communication openings 156, 156 of the respective orifice member 124a, 124b.

By fitting the outer cylindrical metal member 114 onto this assembly 160 by press fitting it about the outside peripheral face thereof, the orifice slots 150, 150 of the first and second orifice members 124a, 124b and the channel 132, by means of being covered by the inside peripheral face (the seal rubber layer 162) of the outer cylindrical metal member 114, form a single orifice passage 126 connecting the first and second fluid chambers 122a, 122b which correspond to the first and second pocket portions 120a, 120b, formed simultaneously.

In the present embodiment, the orifice passage 126 formed in this manner has length, flow passage cross sectional area, and so on that have been tuned so as to exhibit high attenuation of low frequency vibration on the order to 5 to 15 Hz input during driving of the vehicle and causing shimmy occurring due to a relatively small external load; and in particular of input vibration on the low frequency end of about 5 to 10 Hz.

The assembly 160 with the outer cylindrical metal member 114 fitted thereon is then subjected to a reduction process such as 360 degree reduction to reduce the diameter, with the aim of effectively fastening the outer cylindrical metal member 114 thereto; an addition aim is to press the inside peripheral face of the outer cylindrical metal member 114 against the seal beads 144, 158 to produce an adequate seal around the first and second fluid chambers 122a, 122b (the first and second pocket portions 120a, 120b) and the orifice passage 126, as well as about the lightening slots 140, whereupon the suspension bushing 110 like that depicted in FIGS. 7 and 8 is now complete.

As will be apparent from FIGS. 7 and 8, in the suspension bushing 110 of the present embodiment, of the two fluid chambers 122a, 122b, as mentioned previously the first fluid chamber 122a which is afforded by the first pocket portion 120a situated on the side of vibration load input during initial or subsequent acceleration of the vehicle is formed with a portion of the wall thereof constituted by the inner cushion rubber 138 disposed on the floor of the first pocket portion 120a, and the outer cushion rubber 147a of the first orifice member 124a positioned in opposition thereto. The second fluid chamber 122b which is afforded by the second pocket portion 120b situated on the side of vibration load input during braking of the vehicle is formed with a portion of the wall thereof constituted by the floor of the second pocket portion 120b and the outer cushion rubber 147b of the second orifice member 124b positioned in opposition thereto.

The distance: D1 between the inner cushion rubber 138 and the outer cushion rubber 147a of the first orifice member 124a which constitute part of the wall of the first fluid chamber 122a situated on the side of vibration load input during acceleration is established in such a way that when low-frequency vibration on the order of 5 to 15 Hz giving rise to shimmy is input, the inner cushion rubber 138 and the outer cushion rubber 147a will not come into contact with each other, whereas when displacement in the diametrical direction between the inner and outer cylindrical metal members 112, 114 is brought about by load input during sudden acceleration of the vehicle (i.e. relative displacement of the inner and outer cylindrical metal members 112, 114 displacement in the diametrical direction), the two will come into contact with each other.

In this way, in the suspension bushing 110 sufficient fluid flow will be produced through the orifice passage 126 between the first and second fluid chambers 122a, 122b when low-frequency vibration on the order of 5 to 15 Hz giving rise to shimmy is input, whereby excellent vibration absorbing action will be afforded based on the flow behavior and resonance behavior of the fluid, and shimmy will be advantageously prevented. Moreover; during sudden acceleration of the vehicle, the inner cushion rubber 138 and the outer cushion rubber 147a of the first orifice member 124a will come into contact with one another, thereby preventing excessive displacement in the diametrical direction (axis-perpendicular direction) between the inner cylindrical metal member 112 and the outer cylindrical metal member 114 and effectively limiting the amount of displacement of the inner cylindrical metal member 112 with respect to the outer cylindrical metal member 114, in other words, the amount of elastic deformation of the main rubber elastic body 116 which connects the two metal members 112, 114.

Moreover, in the present embodiment, the distance: D2 between the floor of the second pocket portion 120b and the outer cushion rubber 147b of the second orifice member 124b which constitute part of the wall of the second fluid chamber 122b situated on the side of vibration load input during braking is established in such a way that they will come into contact with one another in the event of displacement in the diametrical direction between the inner and outer metal members 112, 114 (i.e. relative displacement of the inner and outer cylindrical metal members 114, 112 displacement in the diametrical direction) caused by a high load input during braking. Given the placement of the first pocket portion 120a, during braking the inner cylindrical metal member 112 and the outer cylindrical metal member 114 will be induced to undergo relative displacement so that inner cushion rubber 138 and the outer cushion rubber 147a of the first orifice member 124a move away from each other, and therefore the inner cushion rubber 138 and the outer cushion rubber 147a of the first orifice member 124a will not come into contact with each other.

By means of this arrangement, in the suspension bushing 110 of the present embodiment, the floor of the second pocket portion 120b and the outer cushion rubber 147b of the second orifice member 124b will be prevented from experiencing excessive displacement in the diametrical direction (axis-perpendicular direction) between the inner cylindrical metal member 112 and the outer cylindrical metal member 114 during braking, thereby affording effective functioning as a stopper mechanism for limiting the amount of displacement of the inner cylindrical metal member 112 relative to the outer cylindrical metal member 114, in other words, the amount of elastic deformation of the main rubber elastic body 116 which connects the two metal members 112, 114.

Where the distance: D2 between the floor of the second pocket portion 120b and the outer cushion rubber 147b has been set to a value smaller than that established in the present embodiment for example, that is, where the floor of the second pocket portion 120b and the outer cushion rubber 147b of the second orifice member 124b are urged into contact with one another by a load lower than the high load input during braking, the result will be that when a high load is input during braking, the floor of the second pocket portion 120b and the outer cushion rubber 147b of the second orifice member 124b will push against each other and contact on another with a certain extent of elastic deformation, thus unavoidably resulting in hard spring properties on the part of the floor portion and the outer cushion rubber 147b respectively during braking.

On the other hand, where the distance: D2 between the floor of the second pocket portion 120b and the outer cushion rubber 147b has been set to the value taught in the present embodiment, i.e. so that the floor of the second pocket portion 120b and the outer cushion rubber 147b of the second orifice member 124b come into contact only when a high load is input during braking, the floor of the second pocket portion 120b and the outer cushion rubber 147b of the second orifice member 124b will come into soft contact with each other during braking.

Consequently, in the present embodiment, when high load is input during braking the floor portion, inclusive of the floor of the second pocket portion 120b, as well as the outer cushion rubber 147b of the second orifice member 124b will undergo elastic deformation with sufficiently soft spring properties, and flow of fluid through the orifice passage 126 will take place in a reliable manner. Thus, on the basis of the flow behavior and resonance behavior of the fluid, effective attenuating action will be achieved against low-frequency vibration on the order of 5 to 15 Hz giving rise to brake jitter caused by vibration in generally the same low-frequency range as shimmy, and as a result the occurrence of brake jitter will be effectively prevented.

The distance: D1 between the inner cushion rubber 138 of the first pocket portion 102a and the outer cushion rubber 147a of the first orifice member 124a, and the distance: D2 between the floor of the second pocket portion 120b and the outer cushion rubber 147b of the second orifice member 124b are not limited to any particular values, and may be determined appropriately with reference to the static spring constant of the main rubber elastic body 116, the vehicle weight, the magnitude of the input load when shimmy occurs or during acceleration, or other factors; herein, a range of between 1 and 3 mm is used for the former distance: D1, and a range of between 2 and 5 mm is used for the latter distance: D2.

The suspension bushing 110 of the present embodiment is constituted in such a way that, during sudden acceleration or braking of the vehicle in which it is installed, elastic deformation of the main rubber elastic body 116 will be limited through contact of the outer cushion rubber 147a of the first orifice member 124a with the inner cushion rubber 138 disposed on the floor of the first pocket portion 120a, or by contact of the outer cushion rubber 147b of the second orifice member 124b with the floor of the second pocket portion 120b, thereby advantageously preventing damage caused by excessive deformation of the main rubber elastic body 116, and advantageously improving its durability.

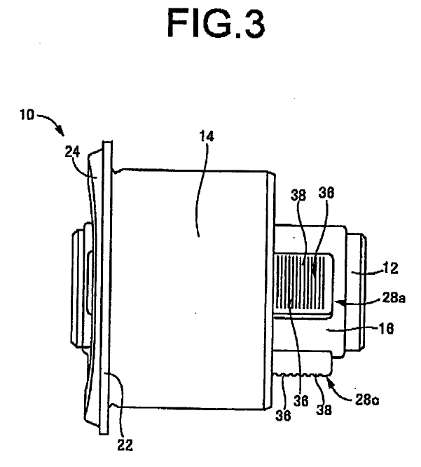

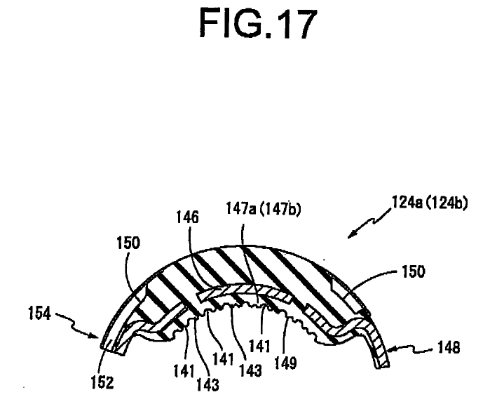

### BRIEF DESCRIPTION OF THE DRAWINGS

[FIG. 1] It is a front elevational view of a suspension bushing according to a first embodiment of the present invention with an outer cylindrical metal member subjected to a diameter-reducing process.

[FIG. 2] It is a cross sectional view taken along line 2-2 of FIG. 1.

[FIG. 3] It is a side elevational view of the suspension bushing.

[FIG. 4] It is a fragmentally enlarged view of the outer cylindrical metal member of the suspension bushing, which is not yet subjected to the diameter-reducing process.

[FIG. 5] It is a fragmentally enlarged view of the suspension bushing.

[FIG. 6] It is a top plane view of the suspension bushing that is installed on an automotive vehicle.

[FIG. 7] It is a transverse cross sectional view of a suspension bushing according to a second embodiment of the present invention.

[FIG. 8] These are vertical cross sectional explanatory views, namely, FIG. 8A is an explanatory view in cross section taken along line 8A-8A of FIG. 7, and FIG. 8B is an explanatory view in cross section taken along line 8B-8B of FIG. 7.

[FIG. 9] It is a front elevational view of an integrally vulcanization molded component used in the suspension bushing of FIG. 7.

[FIG. 10] These are explanatory views showing the integrally vulcanization molded component of FIG. 9 in different directions namely,

[FIG. 10A] is a left side elevational view and FIG. 10B is a right side elevational view.

[FIG. 11] These are other explanatory views of the integrally vulcanization molded component of FIG. 9, namely, FIG. 11A is a top plane view and FIG. 11B is a cross sectional view taken along line 11B-11B of FIG. 9.

[FIG. 12] These are other explanatory views of the integrally vulcanization molded component of FIG. 9, namely, FIG. 12A is a cross sectional view taken along line 12A-12A of FIG. 9 and FIG. 12B is a cross sectional view taken along line 12B-12B of FIG. 9.

[FIG. 13] It is a cross sectional view taken along line 13-13 of FIG. 10B.

[FIG. 14] It is a front elevational view of an orifice member of the suspension bushing of FIG. 10.

[FIG. 15] These are explanatory views showing the orifice member of FIG. 14 in different directions, namely, FIG. 15A is a top plane view and FIG. 15B is a bottom plane view.

[FIG. 16] These are other explanatory views of the orifice member of FIG. 14, namely, FIG. 16A is a left side view and FIG. 16B is a cross sectional view taken along line 16B-16B of FIG. 14.

[FIG. 17] It is a cross sectional view taken along line 17-17 of FIG. 16B.

[FIG. 18] It is an explanatory view where the integrally vulcanization molded component of FIG. 14 and the orifice member of FIG. 14 are assembled together and a gutter type projecting portion of the orifice member is installed and positioned with respect to a communication opening.

[FIG. 19] It is a fragmentally enlarged view of the suspension bushing of FIG. 7.

### EXPLANATION OF NUMERALS

10: suspension bushing 12: inner cylindrical metal member 14: outer cylindrical metal member 16: main rubber elastic body 28: inner cushion rubber 30: outer cushion rubber 32: projecting distal edge face 34: projecting distal edge faces 36: grooves 38: lands 110: suspension bushing 112: inner cylindrical metal member 114: outer cylindrical metal member 116: main rubber elastic body 138: inner cushion rubber 147: outer cushion rubber 139: distal edge face 149: distal edge face 141: grooves 143: lands

1. A rubber vibration damping device including: a main rubber elastic body that connects together a first mounting member and a second mounting member; and a stopper mechanism that limits in cushionwise fashion relative displacement of the first mounting member and the second mounting member by means of contact of a pair of contact faces thereof, the rubber vibration damping device being characterized in that a stopper rubber is formed on each of the pair of contact faces in the stopper mechanism and a multitude of parallel grooves and lands are formed on the respective contact faces, with the grooves and lands on one of the contact faces and the grooves and lands on an other of the contact faces oriented in directions intersecting one another.

2. The rubber vibration damping device according to claim 1, wherein a projecting height of the grooves and lands on one of the contact faces differs from a projecting height of the grooves and lands on the other of the contact faces.

3. The rubber vibration damping device according claim 1, wherein one of the contact faces is larger than the other of the contact faces, and a curving portion with a curvature radius greater than a height dimension of the grooves and lands is formed on an edge of a smaller one of the contact faces.

4. The rubber vibration damping device according to claim 1, wherein the grooves and lands on one of the contact faces and the grooves and lands on the other of the contact faces have an intersection angle of between 45 and 135 degrees.

5. The rubber vibration damping device according to claim 1, wherein the grooves and lands, viewed in cross section orthogonal to a direction of extension thereof, have a shape in which a cross sectional area of the lands is greater than a cross sectional area of the grooves, with respect to a reference line connecting intermediate positions between deepest points of the grooves and apical points of the lands in the grooves and lands.

6. The rubber vibration damping device according to claim 1, wherein flat surfaces are formed at distal ends of the lands in the grooves and lands.

7. The rubber vibration damping device according to claim 1, wherein the grooves and lands will extend in a straight-line pattern on the contact faces.

8. The rubber vibration damping device according claim 1, wherein a fluid chamber whose wall is defined by the main rubber elastic body is formed between opposing faces of the first mounting member and the second mounting member with a non-compressible fluid sealed therein, and the pair of contact faces are positioned in opposition within the fluid chamber.

9. A cylindrical fluid filled rubber vibration damping device wherein a shaft member and a intermediate sleeve disposed a prescribed distance away to an outside of the shaft member are connected by a main rubber elastic body; an outer cylindrical member is attached fitting externally about the intermediate sleeve and fluid-tightly covering a plurality of pocket portions formed so as to open onto an outside peripheral face through window portions provided in the intermediate sleeve thereby forming a plurality of fluid chambers respectively having non-compressible fluid sealed therein and giving rise to relative pressure fluctuations during vibrational input; and an orifice passage interconnecting the plurality of fluid chambers is formed so as to afford vibration absorbing action on the basis of a fluid flow behavior induced to flow through the orifice passage during vibrational input, the fluid filled rubber vibration damping device being characterized in that:
a stopper mechanism is positioned in opposition within at least one of the fluid chambers and comes into face-to-face contact thereof in order to provide cushionwise limitation of an amount of relative displacement of the shaft member and the outer cylindrical member; and
in the stopper mechanism, stopper rubbers are formed on each of a pair of contact faces urged into mutual contact, with a multitude of parallel grooves and lands formed on the respective contact faces, and with the grooves and lands on one of the contact faces and the grooves and lands on an other of the contact faces oriented in directions intersecting one another.

10. The cylindrical fluid filled rubber vibration damping device according to claim 9, wherein the stopper mechanism comprises a first contact portion formed by a rubber elastic body supported by the outer cylindrical member and formed so as to project inwardly in an axis-perpendicular direction within the fluid chamber, and a second contact portion supported by the shaft member and formed so as to project outwardly in the axis-perpendicular direction from a floor of the pocket portion within the fluid chamber so as to be positioned in opposition to the first contact portion in the axis-perpendicular direction, and the pair of contact faces comprise a projecting distal end face of the first contact face and a projecting distal end face of the second contact face.

11. The rubber vibration damping device according to claim 1, wherein the multitude of grooves and lands on at least one of the first contact portion and the second contact portion are of multiple types that differ in cross sectional shape.

12. The rubber vibration damping device according to claim 11, wherein the multiple types of grooves and lands having different cross sectional shapes include those of different height or depth.

13. The rubber vibration damping device according to claim 12, wherein the grooves having different depths are formed to be parallel one another alternately.

14. The rubber vibration damping device according to claim 1, wherein the grooves and lands in the first contact portion and the second contact portion extend up to outside edges of the contact faces, and with the first contact portion and second contact portion in a state of contact with each other, the grooves and lands open onto outside peripheral portions of the contact faces.
